(19) United States
(12) Patent Application Publication
(10) Pub. No.: US 2026/0167046 A1
(43) Pub. Date: Jun. 18, 2026

(54) STATIONARY VEHICLE BATTERY CHARGER MODULATION STRATEGY

(71) Applicant: BorgWarner Inc., Auburn Hills, MI (US)

(72) Inventor: Luca Di Carlo, Royal Oak, MI (US)

(21) Appl. No.: 18/979,157

(22) Filed: Dec. 12, 2024

(51) Int. Cl. B60L 53/67; B60L 53/16; B60L 53/66; H02J 3/01

(52) U.S. Cl. CPC B60L 53/67; B60L 53/16; B60L 53/66; H02J 3/01

(57) ABSTRACT

A stationary vehicle battery charger includes a plurality of power modules and a plurality of charging plugs. Two or more of the modules are included in a synchronization block for the purpose of supplying electrical charging current to a single charging plug. One module in the block is defined as a primary module with remaining modules being secondary modules. The respective outputs of the primary and secondary modules are synchronized using a synchronization signal, which is generated by each module and can include associated output signal timing/phase information. The synchronization signals are exchanged over a bidirectional data bus. Each module is configured to regulate the phase (e.g., by phase offset) of its own output signal so that collectively, the summed output of the synchronized modules exhibits a reduced charging current ripple relative to the output of a single module, without the need for an external inductor-capacitor circuit.

### GOVERNMENT INTEREST

This invention was made with government support under the DE-EE0009869 contract, awarded by the United States Department of Energy, Energy Efficiency & Renewable Energy EE-1 Office. The U.S. Government has certain rights in the invention.

### TECHNICAL FIELD

The present application relates generally to stationary vehicle battery chargers and more particularly to a stationary vehicle battery charger modulation strategy.

### BACKGROUND

This background description is set forth below for the purpose of providing context only. Therefore, any aspects of this background description, to the extent that it does not otherwise qualify as prior art, is neither expressly nor impliedly admitted as prior art against the instant disclosure.

Past stationary vehicle battery chargers include a plurality of power modules and charging plugs that electrically connect the power modules to a battery electric vehicle (BEV). The number of power modules that supply electric current to a BEV can selectively vary and the power modules are not typically synchronized among each other. Thus, as the number of power modules used with one plug increases, the possibility that the current output aligns in-phase and the additive nature of the currents can exceed relatively stringent ripple current thresholds. Stationary vehicle battery chargers can compensate for larger ripple currents using an inductor-capacitor (LC) circuit. But the capacitor and inductor in such a circuit add cost to the vehicle battery charger. It would be helpful to regulate the ripple current without the use of such an LC circuit.

### SUMMARY

In one implementation, a method is provided of operating a stationary vehicle battery charging system having a first plurality of power modules and a second plurality of charging plugs. The method includes the step of establishing a synchronization block comprising two or more of the first plurality of power modules for charging through one of the charging plugs connected to a battery electric vehicle (BEV). The method further includes the steps of communicating at least one synchronization signal among the synchronization block power modules to synchronize respective outputs for reducing charging ripple and charging the BEV using the synchronization block power modules.

A system for operating a charging system is also presented.

### BRIEF DESCRIPTION OF THE DRAWINGS

FIG. 1 is a diagrammatic and block diagram view depicting an implementation of a stationary vehicle battery charging system;

FIG. 2 is a block diagram depicting a portion of a power module;

FIGS. 3-5 are block diagrams depicting various synchronization blocks of power modules, in an implementation;

FIG. 6 depicts timing diagrams showing how phase-shifted outputs from a plurality of power modules combine to achieve a reduced ripple magnitude total output current.

FIG. 7 is a flowchart depicting an implementation of a portion of a method of operating a charging system.

### DETAILED DESCRIPTION

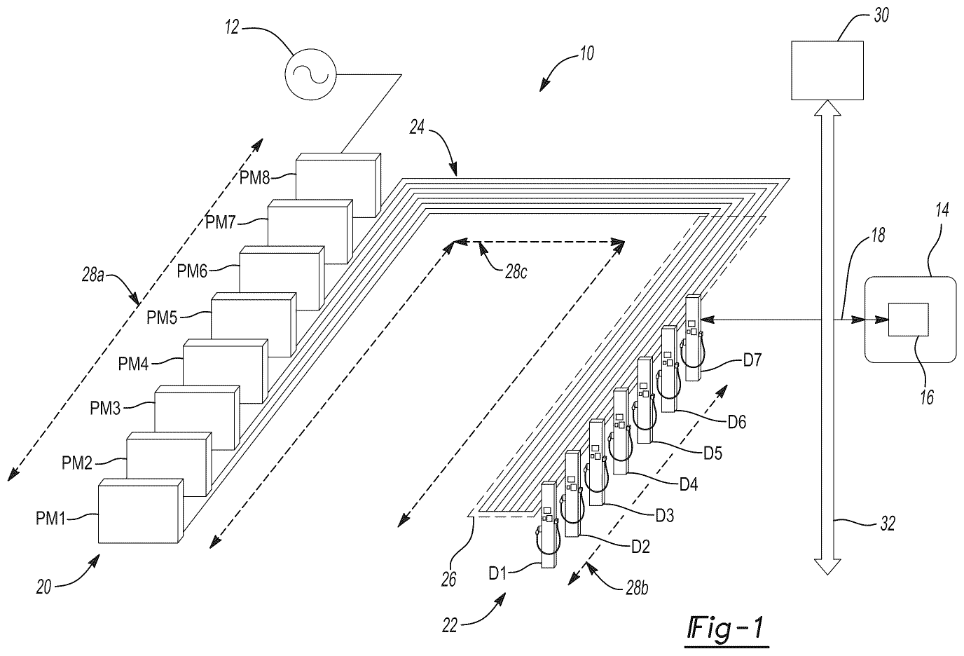

Referring now to the drawings wherein like reference numerals are used to identify identical or similar components in the various views, FIG. 1 is a simplified diagrammatic and block diagram view depicting an implementation of a stationary vehicle battery electrical charging system 10. The system 10 is configured to be electrically connected to a source of AC power such as an electrical grid 12 and is further configured generally to output DC power for a DC load, such as a battery electric vehicle 14 for directly charging a rechargeable battery 16 thereof. The charging system 10 may be a DC fast charging system. The grid 12 may include any one of a number of electrical power generators and electrical delivery mechanisms. In an embodiment, the grid 12 may provide three-phase AC power at 480 VAC at 60 Hz. As shown, the system 10 includes an output connector or charging plug 18 configured for use in connecting the output of the system 10 to the BEV 14.

The system 10 further includes a plurality of power modules 20, a plurality of dispensers 22, direct current (DC) delivery cables 24, a switch matrix 26, first, second, and third communication buses 28a, 28b, 28c, respectively, and a main control 30 connected to the dispensers and power modules via a network facility 32.

The power modules 20 are configured to convert AC power into DC power. FIG. 1 shows eight individual power modules designated PM1, PM2, PM3, PM4, PM5, PM6, PM7, and PM8 although it should be understood that the illustration of eight power modules is for description purposes only. Each module PM1-PM8 is electrically connected, at an input thereof, to the grid 12 and is configured generally to rectify input AC power from the grid 12 and output DC power (when active) to a respective one of the DC delivery cables 24. Each power module PM1-PM8 therefore generates an output signal having a DC component. In addition, each output signal from a power module also has an AC component corresponding to a ripple current and voltage. The AC component may have a frequency at the grid line frequency or alternatively at some other frequency that is dependent on the particular conversion topology being used in the power modules of charging system 10. In an embodiment, each module PM1-PM8 may be configured to have a DC output power capacity of various magnitudes (e.g., 60 kW). The AC/DC electrical power conversion functionality of the power modules PM1-PM8 may comprise approaches known in the art.

The dispensers 22 are configured to include a respective charging plug 18 configured to be connected to an input port or the like of a battery electric vehicle (BEV) 14 to directly charge the BEV's rechargeable battery 16. FIG. 1 shows seven individual dispensers designated D1, D2, D3, D4, D5, D6, and D7, although it should be understood that the illustration of seven dispensers is for description purposes only. Dispensers D1-D7 are each electrically connected to the switch matrix 26 to access DC power originating from one or more of the power modules PM1-PM8 and each also includes a respective connector (or charging plug) 18. While each dispenser is illustrated as including one charging plug 18, it should be understood that this is exemplary only and not limiting in nature.

DC delivery cables 24 include a plurality of individual cables so as to provide respective electrically conductive paths from each power modules PM1-PM8 to the switch matrix 26. The cables 24 may comprise conventional materials and construction.

The switch matrix 26 has an input side configured to receive DC delivery cables 24 and an output side connected to the dispensers D1-D7. The switch matrix 26 is configured to connect any one or more of the power modules PM1-PM8 to a dispenser (one of D1-D7). While the switch matrix 26 is illustrated as separate switching equipment apart from the power modules and dispensers, it should be understood that this is for purposes of description only. In other embodiments, the switch matrix 26 may be incorporated into the power module (or power cabinet—not shown), dispenser, both, or as separate switching equipment as shown. The switch matrix 26 may comprise conventional materials and construction.

The communication data buses 28a, 28b, and 28c are configured for intra-power module communications, intra-dispenser communications, and inter-power module-dispenser communications, respectively. It should be understood that while three separate buses 28a-28c are shown, this is for purposes of description only and alternatively a single bus 28 may be provided to support all of the above-described communications. In an implementation, at least the communication data bus 28a is a bidirectional data bus that connects the power modules 22 (PM1-PM8) for bidirectional communications therebetween.

The main control 30 is configured to provide oversight control of the operation of the charging system 10, receiving status and operating data from power modules PM1-PM8 and dispensers D1-D7 as well as providing additional functionality to the operation of the system 10. For example, the main control 30 can be configured to assign one or more of the power modules PM1-PM8 to one of the charging plugs 18 for purposes of servicing the power request made by the BEV 14 into which the charging plug 18 has been inserted. The main control 30 is configured to communicate with the other components of the charging system 10 through a network interface and underlying network transport facility 32, which may comprise conventional communications components.

As described in the Background, an off board charging system often makes use of several power modules concurrently working in the charging process. The operation of the different power modules in the charging system may be coordinated at some level, for example, with respect to a charging start time and charging stop time, the management of faults, as well as implementing a charging profile requested by the battery electric vehicle (BEV). One of the most stringent requirements in the charging standards pertains to electrical current and voltage ripple limits. Because the operation of the power modules is not synchronized in these types of background charging systems, their current and voltage outputs can be in-phase or close to being in phase, such that a ripple current and voltage effect becomes additive. Such charging systems often comply with applicable ripple limits through a hardware approach involving the use of an expensive external filter (e.g., an inductor/capacitor LC filter).

According to an implementation, a modulation strategy for controlling a stationary vehicle battery charger involves determining and exchanging a synchronization signal between two or more power modules included in a so-called synchronization block. A synchronization block defines those power modules whose output will be combined (i.e., summed) to supply power to and through a single charging plug 18 (i.e., those power modules assigned to the same plug). Thus, for example, in a two power module synchronization block, a first power module generates a first output signal having a first DC component and a first AC component, and a second power module generates a second output signal having a second DC component and a second AC component. Individually, the first AC component output may have a certain frequency and a certain ripple magnitude. Individually, the second AC component may also have the same general frequency and the same general ripple magnitude.

The operation and resulting outputs of the power modules in any particular synchronization block will be synchronized in accordance with the above-mentioned synchronization signal, which contains information that allows the power modules to selectively phase shift their outputs to reduce a ripple magnitude of the combined AC components (ripple) of the synced power modules.

The modulation strategy described herein differs from charger systems where power module output signals assigned to a particular charging plug are being generated in-phase or close to being in-phase. In contrast, the modulation strategy described herein is configured for phase shifting outputs so that the outputs are not in-phase or close to being in-phase so that the combined ripple current or voltage is reduced to acceptable levels.

FIG. 2 is a block diagram depicting one of the power modules PM1-PM8 in greater detail, designated as a power module 38. The power module 38 includes an electronic processor 40, a memory 42, and an AC/DC power conversion block 44. The processor 40 includes processing capabilities as well as an input/output (I/O) interface through which the processor 40 may receive various input signals and generate a plurality of output signals (e.g., power output(s) via block 44). The memory 42 is provided for storage of data as well as instructions or code (i.e., software) for the processor 40. The memory 42 may include various forms of non-transitory memory and may include non-volatile memory for storing and accessing computer-readable instructions executable by processor 40 as well as volatile memory (e.g., such as RAM) for storing and accessing dynamically generated data. The AC/DC power conversion block 44, as general functionality, is shown in simplified form and may comprise systems, topologies, and/or methods in the art.

The power module 38 also includes a power module identification (ID) block 46 and operating logic 48 that is coupled to a synchronization logic block 50 for implementing the synchronization methods described herein. The power module ID 46 may take various forms depending on the implementation, but functionally is used at least for purposes of identifying the particular power module in a synchronization block, which will be described below. The identification PM1-PM8 will be used herein for description purposes of the embodiments and the examples.

The operating logic 48 of each power module 38 includes programmed logic stored in memory 42 which when executed by processor 40 performs a number of functions, including control of charging start and stop times, management and/or reporting of faults and the like, as well as generally conforming its charging output in accordance with a charging profile requested by the vehicle. It should be understood that this description is not exhaustive of the functionality of the operating logic 48.

The synchronization logic 50 in accordance with an implementation includes programmed logic stored in memory 42 which when executed by the processor 40 performs a number of functions described herein, including the generation and transmission of a synchronization signal 51 as well as receiving and interpretation of corresponding synchronization signal(s) received from other power modules assigned to a particular vehicle charging plug (i.e., within the same synchronization block).

The synchronization signal 51 is transmitted/received to/from the bidirectional bus 28a. In an implementation, the synchronization control of the power module output(s) is decentralized in that each power module can regulate the timing or phase of its own electrical current/voltage output relative to the output(s) of other power modules in the synchronization block, in accordance with the received synchronization signal(s) 51. The synchronization logic 50 performs various functions including establishing the synchronization block, determining the identity of the primary and second power modules within a synchronization block, determining its own output timing or phase, determining the output timing/phase of the other power modules in the synchronization block, as well as regulating its own output signal. In an implementation, the synchronization signal may comprise two parts. One part corresponds to digital messages in accordance with a communication protocol that allows the power modules to communicate and ultimately manage the different modules activated for a specific charging session, specify the roles each power module performs (e.g., primary power module, secondary power module(s), etc.) for a specific charging session, and the like. Another part comprises, in an implementation, a pure 50% square wave, synchronized with the working frequency of the power module (e.g., 50 Khz) that will be the heartbeat of the synchronization procedure.

The synchronization signal 51 can be isolated or not isolated depending on the architecture of the charging system. In an implementation, the power modules will be made by different parts that could be galvanically isolated from each other. In general the synchronization signals will be isolated. The synchronization signal 51 can also be distributed in different ways but in an implementation, two power modules (or a multiple of two) may be included in a synchronization block and the synchronization signal 51 is communicated between the power modules in that block.

In an implementation, one of the power modules in the synchronization block is considered to be the master or primary power module and the remainder of the power modules in the synchronization block are considered secondary power module(s). The primary power module generates an output signal with an AC component (ripple) that has a baseline phase characteristic while the secondary power module(s) generate output signals also with AC components (ripple) that have respective offset phase characteristics. The number of power modules contained in a synchronized block may be an odd number as well as an even number, wherein a phase shift is equal to:

$$phase offset = \frac{360 °}{n}$$

where n is the number of power modules in the synchronization block.

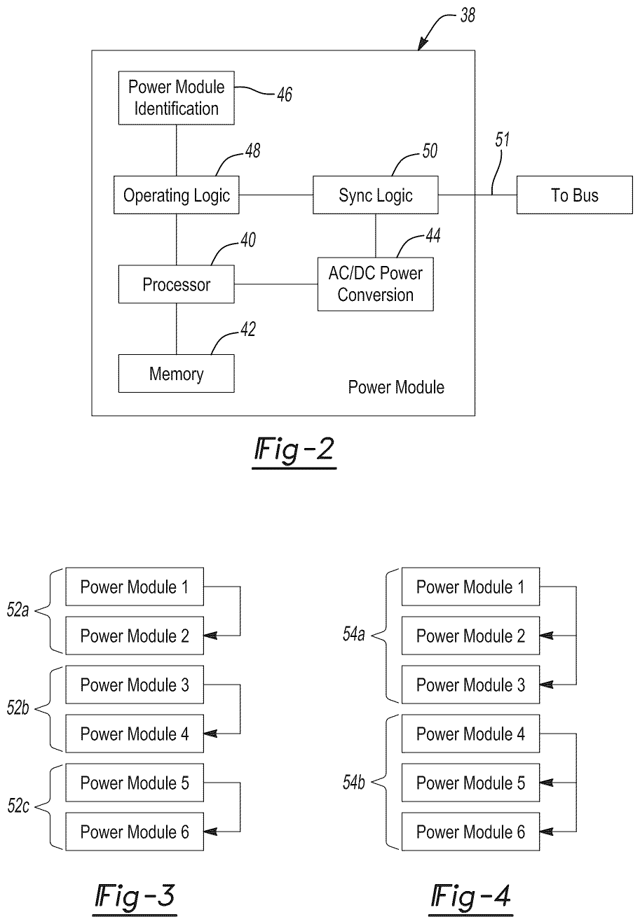

FIGS. 3-5 are block diagrams depicting various synchronization blocks of power modules, in an implementation. As described above, the power modules are connected to communication bus 28a. The primary (main or master) power module in a synchronization block can be dynamically defined, in an implementation. For example, as shown in FIG. 3, in a charging system with six total power modules and three charging plugs equally loaded, there are three defined synchronization blocks 52a, 52b, and 52c, with power modules PM1, PM3, and PM5 being the respective primary (main) power modules and power modules PM2, PM4, and PM6 being the respective secondary power modules. Alternatively, power modules PM2, PM4, and PM6 could be the primary (main) power modules in the example of FIG. 3. Thus, the synchronization logic 50 may provide that the lowest module ID 46 (see FIG. 2) in a synchronization block becomes the primary power module or alternatively that the highest module ID 46 in a synchronization block becomes the primary power module. More generally, any module in the synchronization block can be the primary module as it can be a matter of assignment. The foregoing selection of the primary module is an example of role assignment.

Similarly, as shown in FIG. 4, in a charging system with six power modules and two charging plugs equally loaded, two synchronization blocks 54a and 54b are defined, with power modules PM1 and PM4 being the respective primary (main) power modules and power modules PM2/PM3 and PM5/PM6 being respective secondary power modules.

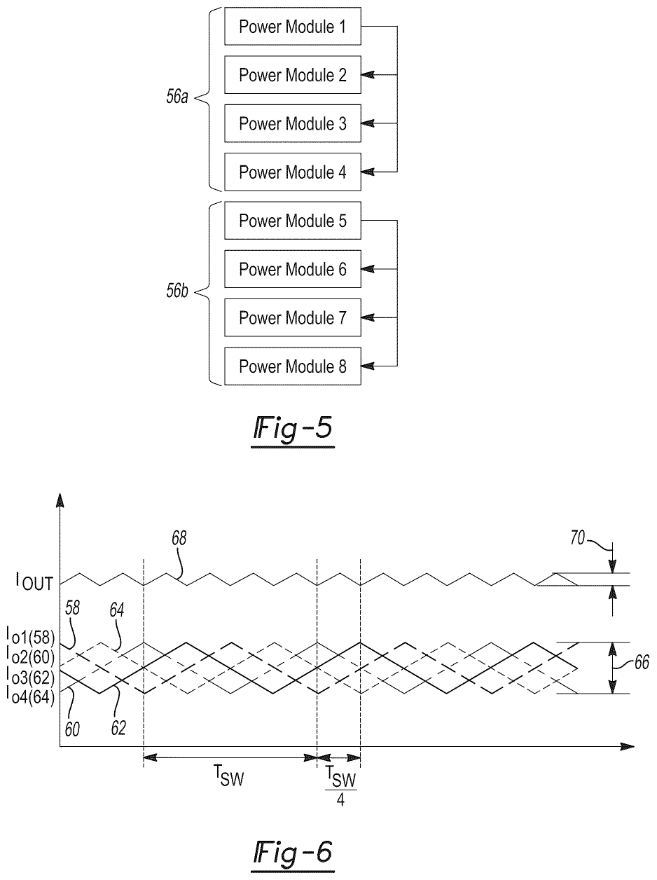

As shown in FIG. 5, in a charging system with eight power modules and four plugs, but only two of the plugs being equally used, there will be two synchronization blocks 56a and 56b defined wherein power modules PM1 and PM5 are the primary (main) power modules with power modules PM2/PM3/PM4 being secondary power modules in the block with PM1 and power modules PM6/PM7/PM8 being the secondary power modules in the block with PM5.

In the same charging system as shown in FIG. 5, if one charging plug will be used, the primary (main) power modules can be any one of the eight power modules PM1-PM8.

FIGS. 3-5 thus illustrate a method of establishing a synchronization block and the primary (master) module therefor, which includes the step of determining a first number of charging plugs that have been connected to a respective BEV and that will be used. Next, determining a second number (total number) of available power modules included in the charging system 10. Finally, determining a third number n of power modules to include in a synchronization block, which is based on at least the first number and the second number. For example, in FIG. 3, the first number of charging plugs to be used is three, the second number of power modules is six, and thus the number of power modules to include in a sync block is two (i.e., six power modules divided by three charging plugs).

FIGS. 3-5 also illustrate how the master synchronization power module can be defined dynamically to establish blocks of synchronized power modules, with each synchronization block corresponding to a charging plug that is to be used. It should be appreciated that it is possible to activate, for charging purposes, less than all of the power modules in a synchronization block of power modules. For example, activating as few as just two power modules would still provide the benefit of ripple minimization.

FIG. 6 depicts traces corresponding to the respectively phase-shifted output currents generated by four power modules, shown on a common timeline. Traces 58 (I_{O1}), 60 (I_{O2}), 62 (I_{O3}), and 64 (I_{O4}) show the respective AC components of the output electrical current of four power modules synchronized in a synchronization block. The period of the AC components is indicated as TSW. As also shown, each individual power module will have a ripple magnitude 66. One of the power modules will be considered the primary (main) power modules and will have an output with an AC component having a baseline phase characteristic. The remaining power modules in the synchronization group will be considered secondary power modules and will have an output with a respective AC component each having a respective offset phase characteristic that increases progressively. The phase shift will be as set forth above, and since the number of power modules n is four, the phase offset will be TSW/4, as also shown in FIG. 6. The summation of the four output signals 58-64 is shown as the output current trace 68 (I_{OUT}), which has a reduced ripple magnitude 70 that is less than the ripple magnitude 66 of any individual power module output. It should be understood that from FIG. 6, the four traces are being generated from four synchronized power modules, with one of the power modules performing the role of the primary module having a baseline or reference phase, with the other three synchronized power modules performing the role of secondary modules and exhibiting a progressively larger phase offset relative to the baseline (e.g., the baseline module=0°; the next module is 90° phase offset; the next module is 180° phase offset; the next module is phase offset) 270°. In ideal circumstances, the resulting AC component (ripple current) would be zero.

In one implementation, the primary power module commands the secondary power modules their respective phase offset values to use in generating respective output signals. In another implementation, each power module is configured to calculate its own phase offset based on information pertaining to its role (primary or secondary) and position in the synchronization block.

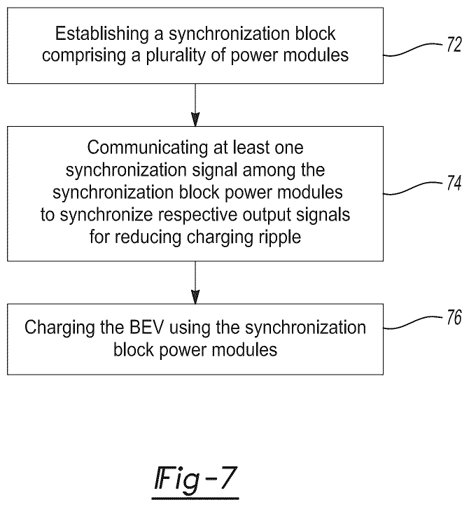

FIG. 7 is a flowchart showing a method of an aspect of operating a stationary vehicle battery charging system having a first plurality of power modules and a second plurality of charging plugs. The method begins at step 72.

In step 72, the charging system 10 (or portions thereof) establishes at least one synchronization block, each block comprising two or more of the power modules, for the purposes of charging through one of the charging plugs that is connected to a battery electric vehicle (BEV). The step 72 may be performed as described above. The method proceeds to step 74.

In step 74, the method involves communicating at least one synchronization signal among the synchronization block power modules to synchronize respective output signals for reducing charging ripple. The step 74 may be performed as described above. The method proceeds to step 76.

In step 76, the method involves charging the BEV using the synchronization block power modules. The step 76 may be performed as described above.

It should be understood that the above steps may be performed in various ways as described herein. The charging system 10 (or portions thereof) may configure a first power module in the synchronization block—the primary power module—to generate a first output signal having a first direct current (DC) component and a first alternating current (AC) component having a baseline phase characteristic. The first AC component has a first ripple magnitude.

The charging system 10 (or portions thereof) may configure a second (or multiple secondary) power module(s) in the same synchronization block to generate a (or multiple) second output signal(s) having second DC component(s) and second AC component(s) having respective offset phase characteristic(s) that are determined such that the sum of the first AC component and the second AC component(s) results in a combined charging ripple magnitude (i.e., output being delivered to a single charging plug) that is less than the first ripple magnitude (i.e., of a single power module alone). For example only, in an implementation, if three power modules are assigned to a charging plug and thus constitute a synchronization block, the three power modules can send—over the bus—the timing and phase information regarding the electrical current the power modules supply through the plug. Each of the other power modules can receive the timing/phase information of the other power modules via the bus and shift the phase/timing based on the power output of the other two power modules. The timing and phase of the three power modules can be set so that the summed current is reduced, and within a current ripple threshold, in an embodiment, without the use of a passive L-C circuit.

Further, the charging system 10 (or portions thereof) may connect (e.g., via the switch matrix 26) the first (primary) and second (or multiple secondary) power modules in the synchronization block to the charging plug connected to a BEV. The charging system 10 (or portions thereof) may further control the first (primary) and second (or multiple secondary) power modules in the synchronization block to generate the first and second (or multiple secondary) output signals. As a result, in an implementation, an output ripple current is reduced, by virtue of phase shifting outputs, especially where multiple power modules are used concurrently for charging through a single plug-which obviates the need for external/expensive L-C filter(s). The modulation strategy described herein thus reduces system cost as well as improves efficiency, in implementations.

It should be understood that an electronic processor as described herein may include conventional processing apparatus known in the art, capable of executing pre-programmed instructions stored in an associated memory, performing in accordance with the functionality described herein. To the extent that the methods described herein are embodied in software, the resulting software can be stored in an associated memory and can also constitute the means for performing such methods.

It should be further understood that an article of manufacture in accordance with this disclosure includes a computer-readable storage medium (non-transitory) having a computer program encoded thereon for implementing the logic described herein. The computer program includes code to perform one or more of the methods and steps thereof disclosed herein. Such embodiments may be configured to execute on one or more processors, multiple processors that are integrated into a single system or are distributed.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method of operating a stationary vehicle battery charging system having a first plurality of power modules and a second plurality of charging plugs, the method comprising the steps of:
establishing a synchronization block comprising two or more of the first plurality of power modules for charging through one of the charging plugs that is connected to a battery electric vehicle (BEV);
communicating at least one synchronization signal among the synchronization block power modules to synchronize respective output signals for reducing charging ripple; and
charging the BEV using the synchronization block power modules.

2. The method of claim 1 further comprising the step of:
providing a bidirectional data bus connecting the first plurality of power modules;
for each power module in the synchronization block, transmitting a respective synchronization signal that includes the at least one synchronization signal, on the bus indicating a respective phase characteristic of an associated output signal;
for each power module in the synchronization block, receiving from the bus the synchronization signals transmitted by the other power modules in the synchronization block;
configuring a first power module in the synchronization block to generate a first output signal having a first direct current (DC) component and a first alternating current (AC) component having a baseline phase characteristic wherein the first AC component has a first ripple magnitude;
configuring a second power module in the synchronization block to generate a second output signal having a second DC component and a second AC component having an offset phase characteristic that is determined such that the sum of the first AC component and the second AC component results in an charging ripple magnitude that is less than the first ripple magnitude; and
for each power module in the synchronization block, modulating, in accordance with the received synchronization signals, respective output signals by phase shifting such that the sum of the associated AC components of the respective output signals is reduced relative to the first ripple magnitude.

3. The method of claim 2 further comprising the steps of:
connecting the first and second power modules in the synchronization block to the one connected charging plug; and wherein charging comprises controlling the first and second power modules in the synchronization block to generate the first and second output signals.

4. The method of claim 2 wherein the step of establishing the synchronization block comprises the sub-steps of:
determining a first number of charging plugs that have been connected to a respective BEV;
determining a second number of power modules included in the first plurality of power modules; and
determining a third number n of power modules to include in the synchronization block based on at least the first number and the second number.

5. The method of claim 4 wherein the step of configuring the second power module further comprises the step of:
determining the offset phase characteristic as a function of the third number n of power modules included in the synchronization block.

6. The method of claim 5 wherein the step of determining the offset phase characteristic is defined as:
$$phase offset = \frac{360 °}{n}$$
where n is the number of power modules in the synchronization block.

7. The method of claim 2 further comprising the step of:
determining the first ripple magnitude and the charging ripple magnitude with respect to an AC electrical current.

8. The method of claim 3 wherein the connecting step further comprises:
connecting the first and second power modules in an electrically parallel relationship with respect to the connected charging plug.

9. The method of claim 3 wherein the controlling step further comprises:
for the second power module, phase shifting the second AC component in accordance with the offset phase characteristic.

10. The method of claim 2 further comprising the step of:
configuring a third power module in the synchronization block to generate a third output signal having a third DC component and a third AC component, wherein the offset phase characteristic is a first offset phase characteristic and the third AC component has a second offset phase characteristic;
determining the first and the second offset phase characteristics such that the sum of the first, the second, and the third AC components results in the charging ripple magnitude being less than the first ripple magnitude;
connecting the third power module with the first and second power modules to the one connected charging plug; and
controlling the third power module concurrently with the first and second power modules to generate the first, second, and third output signals.

11. The method of claim 10 further comprising the step of:
configuring a fourth power module in the synchronization block to generate a fourth output signal having a fourth DC component and a fourth AC component having a third offset phase characteristic;
determining the first, the second, and the third offset phase characteristics such that the sum of the first, second, third, and fourth AC components results in the charging ripple magnitude being less than the first ripple magnitude;
connecting the fourth power module with the first, second, and third power modules to the one connected charging plug; and
controlling the fourth power module concurrently with the first, second, and third power modules to generate the first, second, third, and fourth output signals.

12. The method of claim 11 wherein the step of determining the first, the second, and the third offset phase characteristics further comprises the sub-steps of:
determining the first offset phase characteristic to be 90°;
determining the second offset phase characteristic to be 180°; and
determining the third offset characteristic to be 270°.

13. A method of operating a stationary vehicle battery charging system having a first plurality of power modules and a second plurality of charging plugs wherein each charging plug is configured for connection to a respective battery electric vehicle (BEV), the method comprising the steps of:
determining a first number of charging plugs that have been connected to a respective BEV;
establishing a synchronization block of power modules selected from the power modules in the charging system based on the first number of connected charging plugs and a second number of first plurality of power modules in the charging system, wherein power modules in the synchronization block are electrically connected in parallel to one of the connected charging plugs for charging a connected BEV;
configuring a first power module in the synchronization block as a primary power module, further power modules in the block constituting secondary power modules, wherein the first power module is configured to generate a first output signal having a first direct current (DC) component and a first alternating current (AC) component having a baseline phase characteristic and a first ripple magnitude;
configuring the secondary power modules to generate second output signals with second AC components associated therewith each having a respective offset phase characteristic and wherein the offset phase characteristics are selected such that the superposition of the first AC component and the second AC components result in a charging ripple magnitude that is less than the first ripple magnitude;
electrically connecting the primary and secondary power modules to the one connected charging plug; and
controlling the primary and secondary power modules to generate the first and second output signals to supply the one connected charging plug with charging current.

14. The method of claim 13 further comprising the step of:
providing a bidirectional data bus connecting the first plurality of power modules;
for each power module in the synchronization block, transmitting a respective synchronization signal on the bus indicating a respective phase characteristic of an associated output signal;
for each power module in the synchronization block, receiving from the bus the synchronization signals transmitted by the other power modules in the synchronization block; and
for the power modules in the synchronization block, modulating, in accordance with the received synchronization signals, a respective output signal by phase shifting such that the sum of the associated AC components of the respective output signals is reduced relative to the first ripple magnitude.

15. The method of claim 13 wherein the step of establishing the synchronization block comprises the sub-steps of:
determining a first number of charging plugs that have been connected to a respective BEV;
determining a second number of power modules included in the first plurality of power modules; and
determining a third number n of power modules to include in the synchronization block based on at least the first number and the second number.

16. The method of claim 15 wherein the step of configuring the secondary power modules further comprises the step of:
determining the offset phase characteristics as a function of the third number n of power modules included in the synchronization block.

17. The method of claim 16 wherein the step of determining the offset phase characteristics is defined as:
$$phase offset = \frac{360 °}{n}$$
where n is the number of power modules in the synchronization block.

18. The method of claim 13 further comprising the step of:
determining the first ripple magnitude and the charging ripple magnitude with respect to an AC electrical current.

19. The method of claim 13 wherein the first offset phase characteristic is 90°, the second offset phase characteristic is 180°, and the third offset characteristic is 270°.

20. A method of operating a stationary vehicle battery charging system having a plurality of charging plugs each configured for connection to a battery electric vehicle (BEV), the method comprising the steps of:
providing a plurality of synchronized power modules where a modulation control of which is decentralized and configured such that each of the synchronized power modules can regulate a phase of an AC component of respective output signal relative to the other synchronized power modules assigned to a particular charging plug;
connecting the synchronized power modules to a bi-directional data bus to enable transmitting on the bus respective phase information corresponding to an associated electrical current supplied through the particular charging plug and receiving over the bus phase information transmitted by the other synchronized power modules; and
the synchronized power modules selectively shifting, based on the received phase information, a respective phase of respective AC components of the output signals.
